(19) United States
(12) Patent Application Publication
(10) Pub. No.: US 2026/0247408 A1
(43) Pub. Date: Aug. 20, 2026

(54) TRANSMISSION STARTING POINT SIGNALING FOR CHANNEL OCCUPANCY TIME SHARING

(71) Applicant: QUALCOMM Incorporated, San Diego, CA (US)

(72) Inventors: Giovanni Chisci, San Diego, CA (US); Jing SUN, San Diego, CA (US); Chih-Hao LIU, San Diego, CA (US); Stelios STEFANATOS, San Diego, CA (US); Xiaoxia ZHANG, San Diego, CA (US)

(21) Appl. No.: 19/099,296

(22) PCT Filed: Sep. 27, 2023
(86) PCT No.: PCT/US2023/033860

§ 371 Date: Jan. 28, 2025

(30) Foreign Application Priority Data
Sep. 30, 2022 (GR) 20220100800

(51) Int. Cl. H04W 72/25; H04L 27/26; H04W 74/08

(52) U.S. Cl. CPC H04W 72/25; H04L 27/26025; H04W 74/0866

(57) ABSTRACT

Wireless communications systems, apparatuses, and methods are provided. A method of wireless communication performed by a first user equipment (UE) includes receiving, from a second UE, an indicator indicating one or more transmission starting points and transmitting, during a shared channel occupancy time (COT), a sidelink communication at a first transmission starting point of the one or more transmission starting points, wherein the first transmission starting point is based on a priority associated with the sidelink communication.

### CROSS-REFERENCE TOA RELATED APPLICATION

The present application claims priority to and the benefit of Greek Patent Application No. 20220100800, filed Sep. 30, 2022, the disclosure of which is referenced herein in its entirety as if fully set forth below and for all applicable purposes.

### TECHNICAL FIELD

This application relates to wireless communication systems, and more particularly, to transmission starting point signaling for channel occupancy time sharing.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHZ, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first user equipment (UE), may include receiving, from a second UE, an indicator indicating one or more transmission starting points; and transmitting, during a shared channel occupancy time (COT), a sidelink communication at a first transmission starting point of the one or more transmission starting points, wherein the first transmission starting point is based on a priority associated with the sidelink communication.

In an additional aspect of the disclosure, a method of wireless communication performed by a first user equipment (UE) may include transmitting, to second UE, an indicator indicating one or more transmission starting points; and receiving, from the second UE during a shared channel occupancy time (COT), a sidelink communication at a first transmission starting point of the one or more transmission starting points, wherein the first transmission starting point is based on a priority associated with the sidelink communication.

In an additional aspect of the disclosure, a first user equipment (UE) may include a memory; a transceiver; and at least one processor coupled to the memory and the transceiver, wherein the first UE is configured to receive, from a second UE, an indicator indicating one or more transmission starting points; and transmit, during a shared channel occupancy time (COT), a sidelink communication at a first transmission starting point of the one or more transmission starting points, wherein the first transmission starting point is based on a priority associated with the sidelink communication.

In an additional aspect of the disclosure, a first user equipment (UE) may include a memory; a transceiver; and at least one processor coupled to the memory and the transceiver, wherein the first UE is configured to transmit, to second UE, an indicator indicating one or more transmission starting points; and receive, from the second UE during a shared channel occupancy time (COT), a sidelink communication at a first transmission starting point of the one or more transmission starting points, wherein the first transmission starting point is based on a priority associated with the sidelink communication.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates transmission starting points in a shared COT according to some aspects of the present disclosure.

FIG. 4 illustrates transmission starting points in a shared COT for time division multiplexing according to some aspects of the present disclosure.

FIG. 5 illustrates transmission starting points in a shared COT for frequency division multiplexing according to some aspects of the present disclosure.

FIG. 6 illustrates transmission starting points in multiple regions of a shared COT according to some aspects of the present disclosure.

FIG. 7 illustrates transmission starting points in multiple regions of a shared COT according to some aspects of the present disclosure.

FIG. 8 illustrates a signal flow diagram of a communication method according to some aspects of the present disclosure.

FIG. 9 is a block diagram of an exemplary user equipment (UE) according to some aspects of the present disclosure.

FIG. 10 is a block diagram of an exemplary network unit according to some aspects of the present disclosure.

FIG. 11 is a flow diagram of a communication method according to some aspects of the present disclosure.

FIG. 12 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1 M nodes/km2), ultra-low complexity (e.g., ~10 s of bits/sec), ultra-low energy (e.g., ~10+years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHZ BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (Rus)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more Rus. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

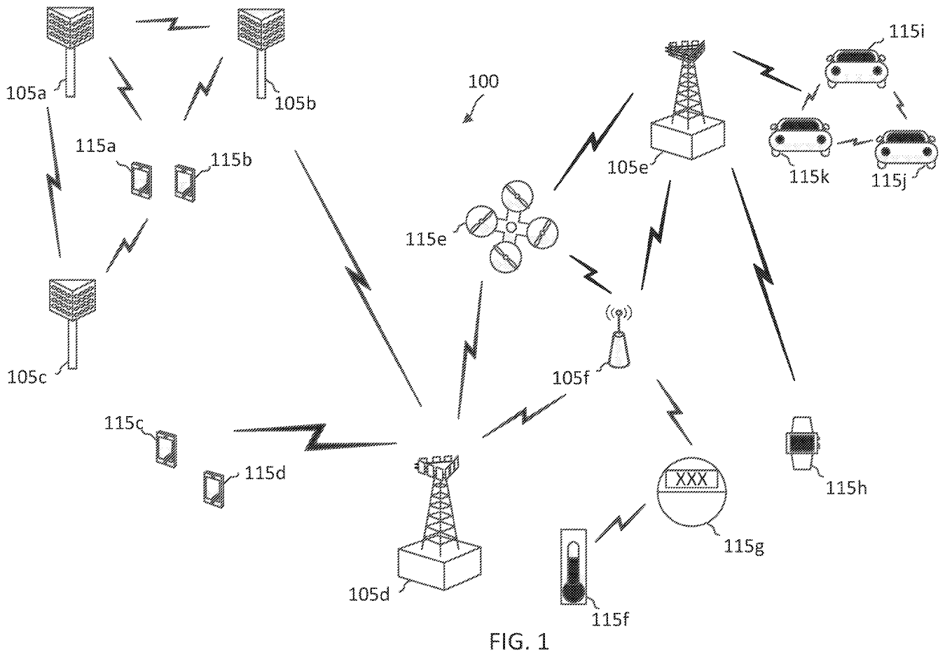

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IOT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105 a-105c may serve the UEs 115 a and 115 b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure.

For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115j may receive an indicator from the UE 115i indicating one or more transmission starting points. The UE 115j may transmit, during a shared channel occupancy time (COT), a sidelink communication at a first transmission starting point of the one or more transmission starting points. In some aspects, the first transmission starting point is based on a priority associated with the sidelink communication.

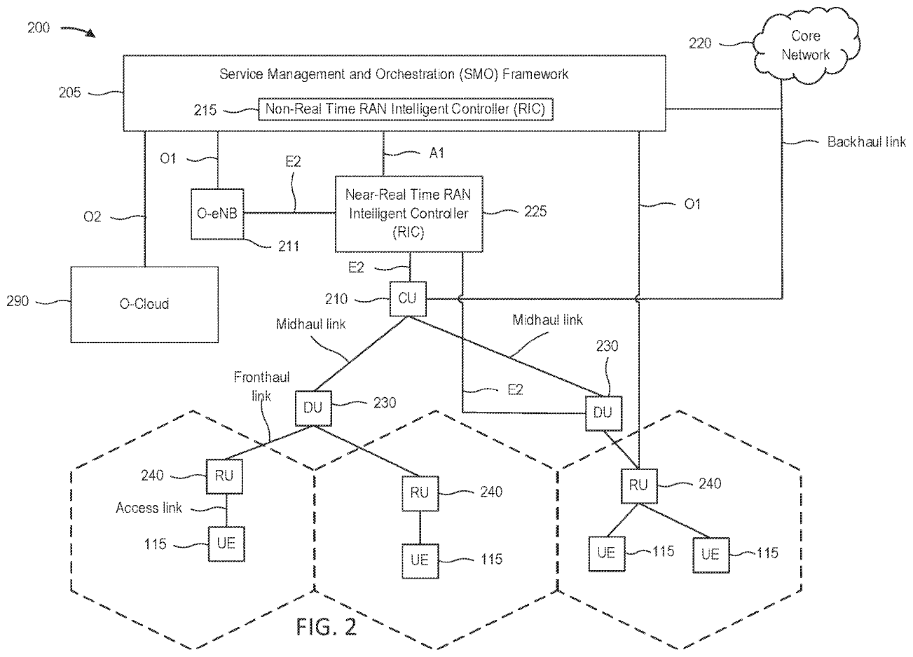

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (Rus) 240 via respective fronthaul links. The Rus 240 may communicate with respective UEs 115 via one or more radio frequency (RF) access links. In some implementations, the UE 115 may be simultaneously served by multiple Rus 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like.

Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more Rus 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, Rus 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more Rus 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, the first UE 115 may receive an indicator from a second UE indicating one or more transmission starting points. The first UE may transmit, during a shared channel occupancy time (COT), a sidelink communication at a first transmission starting point of the one or more transmission starting points. In some aspects, the first transmission starting point is based on a priority associated with the sidelink communication.

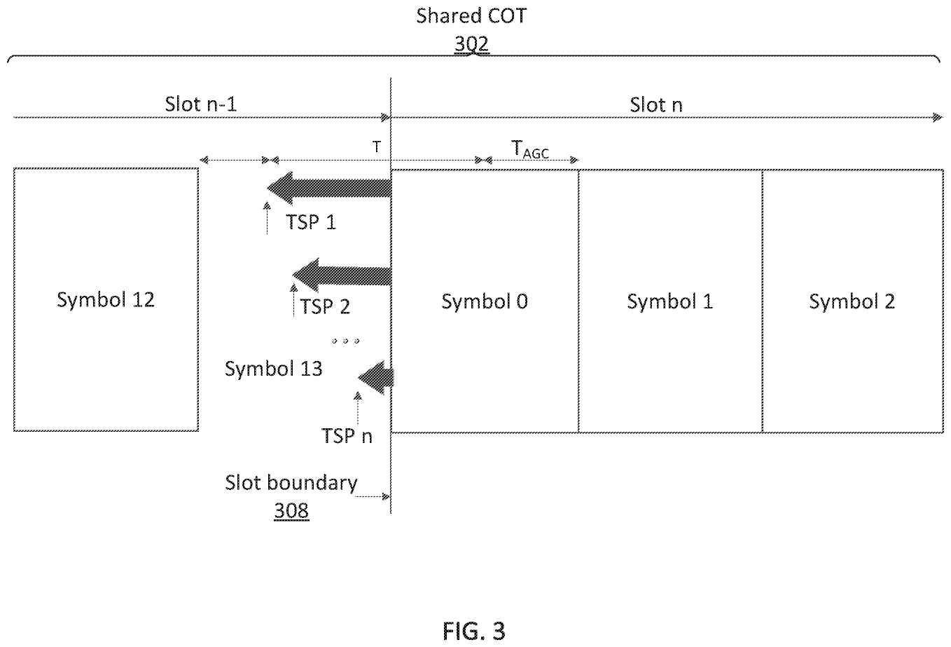

FIG. 3 illustrates transmission starting points in a shared COT 302 according to some aspects of the present disclosure. FIG. 3 shows an example of a COT initiating UE that has acquired a channel occupancy time during which the UE is permitted to transmit on an unlicensed channel in slot n-1 and a responding UE sharing the shared COT 302. The responding UE may determine one or more transmission starting times during which the responding UE may transmit a sidelink communication in order to share the shared COT 302 acquired by the COT initiating UE.

In some aspects, the UE may successfully perform an LBT procedure to acquire a channel occupancy time during which the UE is permitted to transmit on an unlicensed channel. For example, prior to gaining access to, and transmitting over, the unlicensed channel, the UE may perform the LBT procedure to contend for access to the unlicensed channel. In some aspects, the LBT procedure may include a clear channel assessment (CCA) procedure that the UE performs to determine whether the unlicensed channel is available (e.g., unoccupied by other transmitters). In particular, the UE may detect an energy level on the unlicensed channel, and the CCA procedure may be deemed successful if the energy level on the unlicensed channel satisfies (e.g., is less than or equal to) a threshold. In such cases, the UE may gain access to the unlicensed channel to acquire the channel occupancy time during which the UE may perform transmissions without performing additional LBT operations. Additionally, or alternatively, in cases where the energy level detected on the unlicensed channel fails to satisfy (e.g., is greater than or equal to the threshold), the UE may perform the CCA procedure again and acquire the channel occupancy time at a later time.

The COT responding UE may perform the LBT in symbol 13 (e.g., the gap symbol) in slot n-1 just prior to the TSP that corresponds to the CAPC of the communication the first UE intends to transmit in slot n. If the LBT is successful, the first UE may transmit during the CPE between the TSP and the slot boundary 308 (e.g., the boundary between the end of symbol 13 and symbol 0 of slot n). By transmitting during the CPE starting at the TSP, the first UE may block other UEs contending for the shared COT 302. A sidelink communication having a high priority (e.g., a lower CAPC value) may be assigned an earlier TSP than a sidelink communication having a lower priority (e.g., a higher CAPC value). In this way, a COT responding UE having a high priority communication to transmit may be assigned an earlier TSP thereby blocking other COT responding UEs having lower priority communications from gaining the shared COT 302. When more than one COT responding UE has a high priority communication to transmit (e.g., multiple UEs having the same CAPC value), the UEs may compete for an earlier TSP based on a random selection process. The random TSP selection process may provide a random chance for the contending UEs to be assigned the earlier TSP. In this regard, each of the contending UEs may select a TSP based on a hashing function of the multiple TSPs. For example, each of the contending UEs may select a TSP based on a hashing function of the multiple TSPs and a unique identifier associated with the contending UE.

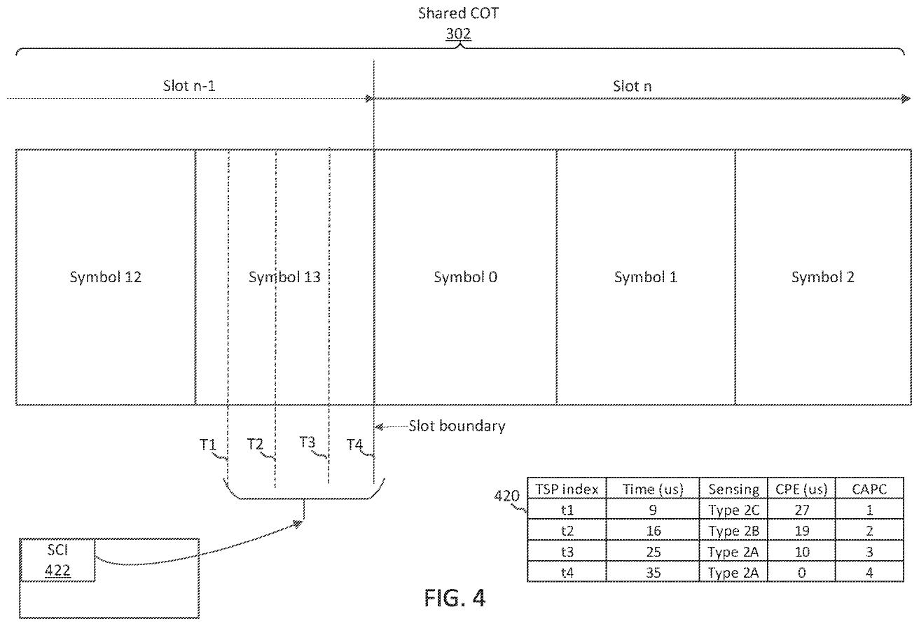

FIG. 4 illustrates transmission starting points in a shared COT 302 for time division multiplexing (TDM) according to some aspects of the present disclosure. In some aspects, a first UE (e.g., a sidelink UE, the UE 115, or the UE 600) may receive an indicator from a second UE (e.g., a sidelink UE, the UE 115, or the UE 600) indicating one or more transmission starting points. In this regard, the first UE may receive the indicator via a sidelink radio resource control (RRC) communication, sidelink control information 422 (e.g., SCI-1, SCI-2), a channel occupancy time (COT) structure indicator (COT-SI), COT sharing information, a physical sidelink shared channel (PSSCH) communication, a physical sidelink control channel (PSCCH) communication, and/or other suitable communication. Additionally or alternatively, the first sidelink UE may receive the indicator from a network unit (e.g., the BS 105, the RU 240, the DU 230, the CU 210, and/or the network unit 1000) via a RRC communication, downlink control information (DCI), a medium access control-control element (MAC-CE), a physical downlink shared channel (PDSCH) communication, a physical downlink control channel (PDCCH) communication, and/or other suitable communication. In some aspects, the transmission starting point(s) may correspond to a starting point of a portion of a shared COT that may be utilized by the first UE for sidelink communications.

In some aspects, the indicator indicating the transmission starting points (TSPs) may include a lookup table 420 mapping a TSP index (e.g., T1-T4) to TSP(s), a channel access priority class (e.g., CAPC 1-CAPC 4), an LBT category type (e.g., type 2A, type 2B, or type 2C), and/or a CPE. For example, the lookup table 420 may include one or more TSP entries that corresponds to a CAPC. In some aspects, each of the TSP(s) may correspond to a different CAPC. In a non-limiting example, a TSP of 9 us may correspond to CAPC 1. A TSP of 16 us may correspond to CAPC 2. A TSP of 25 us may correspond to CAPC 3. A TSP of 35 us may correspond to CAPC 4. In some aspects, multiple TSPs may correspond to the same CAPC. In some aspects, the same TSP may correspond to multiple CAPCs. Lookup table 420 may include any number of TSPs mapped to any number of CAPCs.

The CAPC may be associated with a sidelink transmission. The sidelink transmission may include a transport block transmitted via a PSSCH. The CAPC associated with the sidelink communication may indicate the priority (e.g., latency budget) of the sidelink communication. In some aspects, a higher CAPC value (e.g., 4) may indicate a lower priority level while a lower CAPC value (e.g., 1) may indicate a higher priority level.

In some aspects, the indicator may further indicate a listen-before-talk (LBT) category and/or a LBT category type. The category may include a category 1 LBT, a category 2 LBT, a category 3 LBT, and/or a category 4 LBT. The indicator may further indicate the category type. For example, the category type may include a category type 2A, type 2B, and/or type 2C. The first UE may perform an LBT according to the category and/or category type to gain access to the COT in an unlicensed frequency spectrum during slot n.

In some aspects, the indicator may further indicate a cyclic prefix extension (CPE) length. The first UE may transmit a CPE prior to transmitting a sidelink transmission in slot n to facilitate alignment of orthogonal frequency division multiplexing (OFDM) symbols and retain the shared COT 302 by blocking other UEs contending for the shared COT 302.

In some aspects, the number of TSPs may be based on a subchannel carrier spacing (SCS) associated with the sidelink communication. For example, a lower SCS may correspond to a higher number of TSPs while a higher SCS may correspond to a lower number of TSPs. As a non-limiting example, when the SCS is 15 KHz, the number of TSPs may be 8. As another non-limiting example, when the SCS is 30 KHz, the number of TSPs may be 4. As another non-limiting example, when the SCS is 60 KHz, the number of TSPs may be 2.

In some aspects, the indicator may include one or more codepoint fields. The UE may receive the indicator in one or more codepoint fields via COT structure information (COT-SI), COT sharing information, and/or SCI 422 (e.g., SCI-1, SCI-2). The indicator indicating the TSP(s) may include a first codepoint field indicating a number of TSP(s), a second codepoint field may indicate a location of the TSP(s), and a third codepoint field may map the TSP(s) to the CAPC associated with the sidelink communication. The number of codepoints in each of the first, second, and third codepoints may vary (e.g., a flexible number of codepoints in each codepoint field). However, the total number of bits in the indicator may be fixed and the sum of the first, second, and third codepoint fields may equal the fixed number of bits in the indicator. In some aspects, the first codepoint field may be based on the SCS associated with the sidelink communication in slot n. For example, when the SCS is 15 KHz, the first codepoint field may include 3 bits indicating up to 8 TSPs. When the SCS is 30 KHz, the first codepoint field may include 2 bits indicating up to 4 TSPs. When the SCS is 60 KHz, the first codepoint field may include 1 bit indicating up to 2 TSPs.

In some aspects, the second codepoint field may be based on the number of TSPs in the first codepoint field. In some aspects, the third codepoint field may be based on the number of bits in the first codepoint field (e.g., the number of TSPs which is based on the SCS) and a CAPC associated with the second UE (e.g., a CAPC associated with a sidelink communication transmitted by the COT initiator).

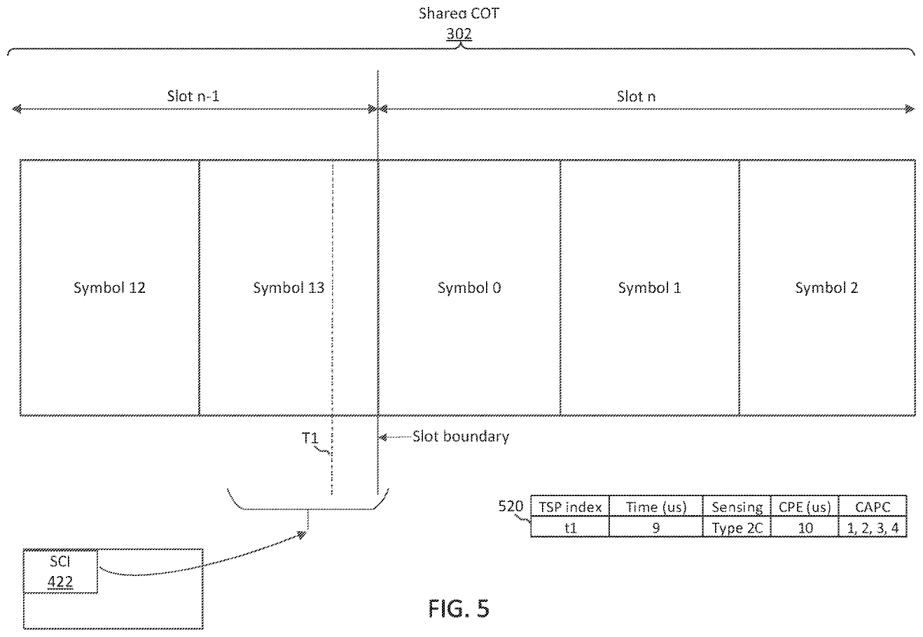

FIG. 5 illustrates transmission starting points in a shared COT 302 according to some aspects of the present disclosure. FIG. 5 illustrates similar COT sharing methods as FIG. 4. In FIG. 4, different TSPs were mapped to different CAPCs to allow higher priority transmissions to gain the shared COT 302 before lower priority transmissions. However, in FIG. 5, the different CAPCs are mapped to the same TSP t1 as shown in lookup table 520. In this way, multiple responding UEs may transmit in the shared COT 302 using frequency division multiplexing (FDM).

In some aspects, the first UE may share the shared COT 302 with other UEs (e.g., other sidelink UEs) based on frequency division multiplexing of the shared COT resources. For example, each of the UEs contending for the shared COT may be assigned a set of unique frequency ranges (e.g., subchannels) to transmit in. The number of subchannels assigned to each UE may be based on a size of the communication to be transmitted (e.g., the TB size). In FDM mode, each of the UEs may be assigned the same TSP allowing communications of the same or different priority to be transmitted at the same time but in different frequency subchannels. The frequency subchannels may include one or more ranges of frequency subchannels and/or one or more frequency subchannel interlaces. Prior to transmitting, each of the UEs contending for the shared COT may perform the LBT type indicated by the lookup table 520 in their respectively assigned subchannels. The UEs that pass the LBT may begin transmitting in their respective subchannels starting at TSP t1.

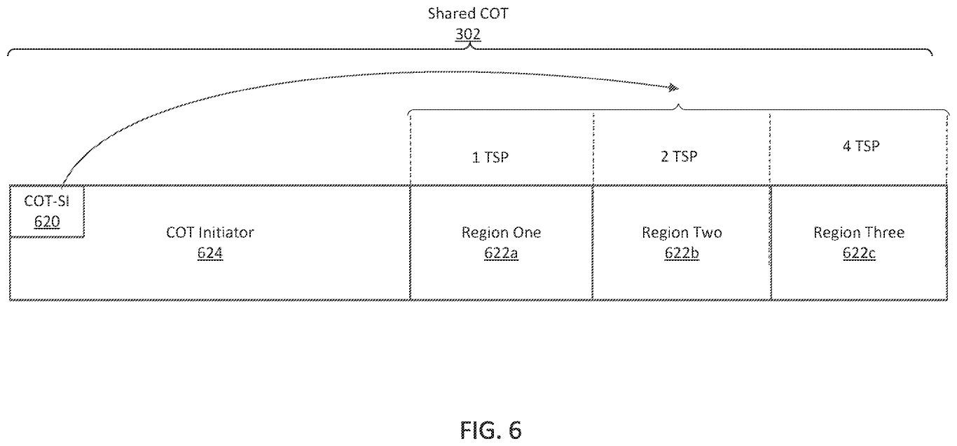

FIG. 6 illustrates transmission starting points in multiple regions 622 of a shared COT 302 according to some aspects of the present disclosure. In some aspects, the shared COT 302 may be divided into multiple COT sharing regions 622. The shared COT 302 may be divided into one, two, three, four, or more COT sharing regions 622. In a non-limiting example shown in FIG. 6., the shared COT 302 may be divided in a region for the COT initiator 624 to transmit communication(s) and three regions (e.g., region one 622a, region two 622b, and region three 622c in which COT responding UE(s) may share the COT and transmit communication(s). Each of the regions 622 may include any number of slots. The COT sharing regions 622 may be overlapping or non-overlapping in time. Each of the COT sharing regions 622 may be used by one or more COT sharing UEs (e.g., a COT responder) to transmit a sidelink communication. Each of the COT sharing regions 622 may be associated with a different indicator (e.g., lookup table) indicating the TSP(s). For example, each of the COT sharing regions 622 may be associated with a lookup table mapping a TSP index to TSP(s), a CPAC, an LBT category type, and a CPE. For example, region one 622a may be associated with a lookup table mapping a single TSP. Region two 622b may be associated with a lookup table mapping two TSPs. Region three 622c may be associated a lookup table mapping 4 TSPs. In some aspects, the second UE (e.g., the COT initiator) may transmit a single indicator in COT structure information (COT-SI) 620 indicating the lookup tables for each of the regions (e.g., three lookup tables for regions 622a, 622b, and 622c).

Additionally or alternatively, the single indicator may be transmitted via SCI (e.g., SCI-1 and/or SCI-2) and/or COT sharing information.

In some aspects, the multiple COT sharing regions 622 may be non-overlapping and contiguous as shown in the example of FIG. 6. In this case, the COT-SI 620 indicating the multiple lookup tables may include a starting point for each of the regions and a single ending point for the last region 622c. In this way, the first UE and other responding UEs may interpret the ending point of a COT sharing region 622 as the starting point of the next contiguous COT sharing region. For example, the end point of region one 622a may be the starting point of region two 622b. The end point of region two 622b may be the starting point of region three 622c. In some aspects, the ending point of the COT sharing regions 622 may be the end of the shared COT 302 (e.g., the end of the maximum COT (MCOT) duration).

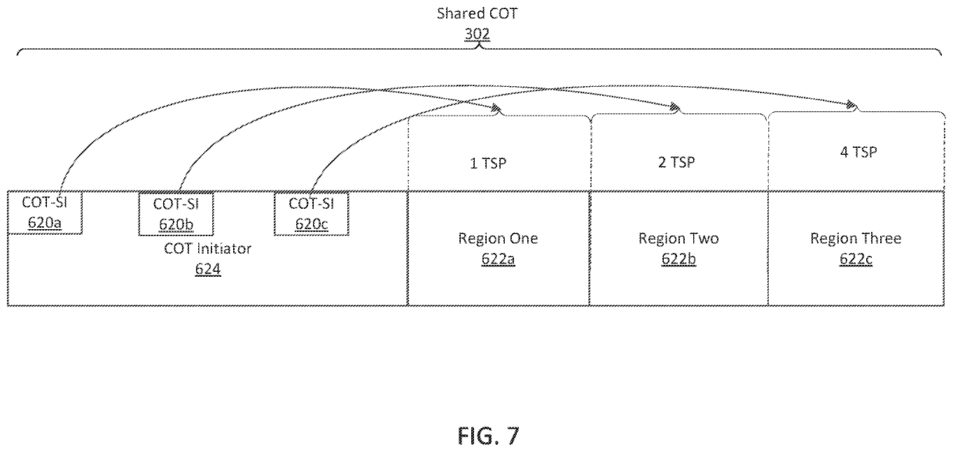

FIG. 7 illustrates transmission starting points in multiple regions 622 of shared COT 302 according to some aspects of the present disclosure. FIG. 7 illustrates a similar shared COT 302 as FIG. 6. but using multiple COT-SIs 620 to indicate the TSP lookup tables associated with the COT sharing regions 622. In some aspects, the shared COT 302 may be divided into multiple COT sharing regions 622. The shared COT 302 may be divided into one, two, three, four, or more COT sharing regions 622. In a non-limiting example shown in FIG. 7., the shared COT 302 may be divided in a region for the COT initiator 624 to transmit communication(s) and three regions (e.g., region one 622a, region two 622b, and region three 622c) in which COT responding UE(s) may share the COT and transmit communication(s). Each of the regions 622 may include any number of slots. The COT sharing regions 622 may be overlapping or non-overlapping in time. Each of the COT sharing regions 622 may be used by one or more COT sharing UEs (e.g., a COT responder) to transmit a sidelink communication. Each of the COT sharing regions 622 may be associated with a different indicator indicating the TSP(s). For example, each of the COT sharing regions 622 may be associated with a lookup table mapping a TSP index to TSP(s), a CPAC, an LBT category type, and a CPE. For example, region one 622a may be associated with a lookup table mapping a single TSP. Region two 622b may be associated with a lookup table mapping two TSPs. Region three 622c may be associated a lookup table mapping four TSPs. In some aspects, the second UE (e.g., the COT initiator) may transmit multiple indicators in COT structure information (COT-SI) 620 indicating the lookup tables for each of the regions (e.g., three lookup tables for regions 622a, 622b, and 622c). For example, COT-SI 620a may indicate the lookup table for region one 622 a, COT-SI 620b may indicate the lookup table for region two 622b, COT-SI 620c may indicate the lookup table for region three 622 c. The COT initiator 624 may transmit the multiple COT-SIs 620 a, 620b, and/or 620c in different time resources (e.g., different slots) and/or in different frequency resources (e.g., different subchannels).

Additionally or alternatively, the multiple indicators may be transmitted via multiple SCIs (e.g., SCI-1 and/or SCI-2) and/or multiple COT sharing information.

In some aspects, the multiple COT sharing regions 622 may be non-overlapping and contiguous as shown in the example of FIG. 7. In this case, the COT-SI 620 indicating the multiple lookup tables may include a starting point for each of the regions and a single ending point for the last region. In this way, the first UE and other responding UEs may interpret the ending point of a COT sharing region 622 as the starting point of the next contiguous COT sharing region. For example, the end point of region one 622a may be the starting point of region two 622b. The end point of region two 622b may be the starting point of region three 622c. In some aspects, the ending point of the COT sharing regions 622 may be the end of the shared COT 302 (e.g., the end of the maximum COT (MCOT) duration).

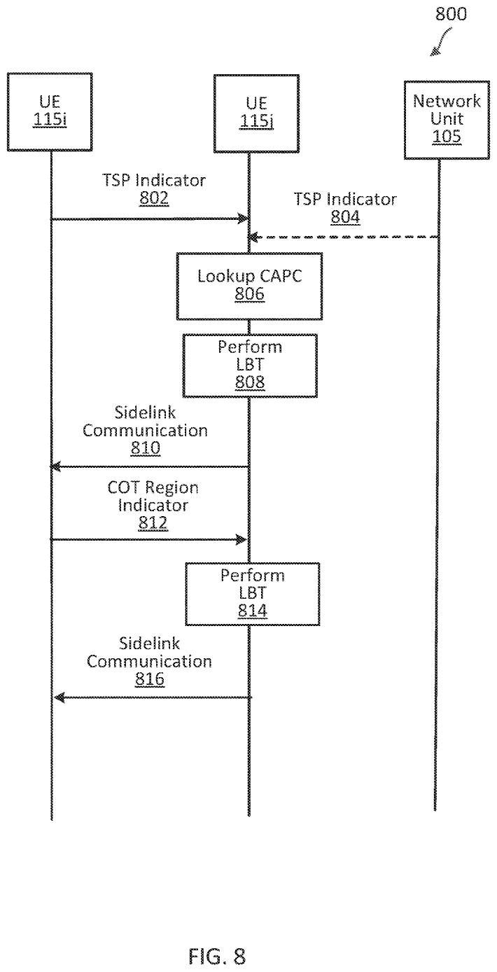

FIG. 8 is a signaling diagram of a wireless communication method 800 according to some aspects of the present disclosure. Actions of the communication method 800 can be executed by a computing device (e.g., a processor, processing circuit, and/or other suitable component) of a communication device or other suitable means for performing the actions. For example, a wireless communication device, such as the UE 115 or UE 900, may utilize one or more components, such as the processor 902, the memory 904, the transmission starting point module 908, the transceiver 910, the modem 912, and the one or more antennas 916, to execute aspects of method 800.

At action 802, the UE 115j may receive an indicator from UE 115i indicating one or more transmission starting points. In this regard, the UE 115j may receive the indicator via a sidelink radio resource control (RRC) communication, sidelink control information (e.g., SCI-1, SCI-2), a channel occupancy time (COT) structure indicator (COT-SI), COT sharing information, a physical sidelink shared channel (PSSCH) communication, a physical sidelink control channel (PSCCH) communication, and/or other suitable communication. In some aspects, the transmission starting point(s) may correspond to a starting point of a portion of a shared COT that may be utilized by the UE 115j for sidelink communications.

At action 804, the UE 115j may additionally or alternatively receive the indicator from network unit 105 via a RRC communication, downlink control information (DCI), a medium access control-control element (MAC-CE), a physical downlink shared channel (PDSCH) communication, a physical downlink control channel (PDCCH) communication, and/or other suitable communication.

In some aspects, the indicator indicating the transmission starting points (TSPs) may include a lookup table mapping a TSP index to TSP(s), a channel access priority class (CAPC), an LBT category type, and/or a CPE. For example, the lookup table may include one or more TSP entries that corresponds to a CAPC. In some aspects, each of the TSP(s) may correspond to a different CAPC. In some aspects, multiple TSPs may correspond to the same CAPC. In some aspects, the same TSP may correspond to multiple CAPCs.

The CAPC may be associated with a sidelink transmission. The transmission may be a transport block transmitted via a PSSCH. The CAPC associated with the sidelink communication may indicate the priority (e.g., latency budget) of the sidelink communication. In some aspects, a higher CAPC value (e.g., 4) may indicate a lower priority level while a lower CAPC value (e.g., 1) may indicate a higher priority level.

In some aspects, the indicator may further indicate a listen-before-talk (LBT) category and/or a LBT category type. The category may include a category 1 LBT, a category 2 LBT, a category 3 LBT, and/or a category 4 LBT. The indicator may further indicate the category type. For example, the category type may include a category type 2A, type 2B, and/or type 2C. The UE 115j may perform an LBT according to the category and category type to gain access to the COT in an unlicensed frequency spectrum.

In some aspects, the indicator may further indicate a cyclic prefix extension (CPE) length. The UE 115j may transmit a CPE prior to transmitting a sidelink transmission to facilitate alignment of orthogonal frequency division multiplexing (OFDM) symbols and retain the shared COT by blocking other UEs contending for the shared COT.

In some aspects, the number of TSPs may be based on a subchannel carrier spacing (SCS) associated with the sidelink communication. For example, a lower SCS may correspond to a higher number of TSPs while a higher SCS may correspond to a lower number of TSPs. As a non-limiting example, when the SCS is 15 KHz, the number of TSPs may be 8. As another non-limiting example, when the SCS is 30 KHz, the number of TSPs may be 4. As another non-limiting example, when the SCS is 60 KHz, the number of TSPs may be 2.

In some aspects, the indicator may include one or more codepoint fields. The UE may receive the indicator in one or more codepoint fields via COT structure information (COT-SI), COT sharing information, and/or SCI (e.g., SCI-1, SCI-2). The indicator indicating the TSP(s) may include a first codepoint field indicating a number of TSP(s), a second codepoint field may indicate a location of the TSP(s), and a third codepoint field may map the TSP(s) to the CAPC associated with the sidelink communication. The number of codepoints in each of the first, second, and third codepoints may vary (e.g., a flexible number of codepoints in each codepoint field). However, the total number of bits in the indicator may be fixed and the sum of the first, second, and third codepoint fields may equal the fixed number of bits in the indicator. In some aspects, the first codepoint field may be based on the SCS associated with the sidelink communication. For example, when the SCS is 15 KHz, the first codepoint field may include 3 bits indicating up to 8 TSPs. When the SCS is 30 KHz, the first codepoint field may include 2 bits indicating up to 4 TSPs. When the SCS is 60 KHz, the first codepoint field may include 1 bit indicating up to 2 TSPs.

In some aspects, the second codepoint field may be based on the number of TSPs in the first codepoint field. In some aspects, the third codepoint field may be based on the number of bits in the first codepoint field (e.g., the number of TSPs which is based on the SCS) and a CAPC associated with the second UE (e.g., a CAPC associated with a sidelink communication transmitted by the COT initiator).

In some aspects, the COT duration may be divided into multiple COT sharing regions as described with reference to FIGS. 6 and 7.

At action 806, the UE 115j may look up the CAPC of the sidelink communication the UE 115j intends to transmit in the lookup table received at action 802 or 804. The UE 115j may obtain the TSP, LBT category type, and/or CPE for the sidelink communication based on the CAPC associated with the sidelink communication.

At action 808, the UE 115j may perform an LBT according to the LBT category type determined by the lookup table at action 806. The UE 115j may perform the LBT according to the category and category type to gain access to the shared COT in an unlicensed frequency spectrum.

At action 810, the UE 115j may transmit a sidelink communication to the UE 115i starting at the TSP indicated in the lookup table based on a successful LBT procedure at action 808. Additionally or alternatively, the UE 115j may transmit a sidelink communication to another sidelink UE or transmit an UL communication to the network unit 105. If the LBT is successful at action 808, the first UE may transmit during the CPE between the TSP and the slot boundary (e.g., the boundary between the end of symbol 13 and symbol 0 of the next slot). By transmitting during the CPE starting at the TSP, the first UE may block other UEs contending for the shared COT. A sidelink communication having a high priority (e.g., lower CAPC value) may be assigned an earlier TSP than a sidelink communication having a lower priority (e.g., higher CAPC value). In this way, a UE having a high priority communication to transmit may be assigned an earlier TSP thereby blocking other COT sharing UEs having lower priority communications from gaining the shared COT. When more than one UE has a high priority communication to transmit (e.g., multiple UEs having the same CAPC value), the UEs may compete for an earlier TSP based on a random selection process. The random TSP selection process may provide a random chance for the contending UEs to be assigned the earlier TSP. In this regard, each of the contending UEs may select a TSP based on a hashing function of the multiple TSPs. For example, each of the contending UEs may select a TSP based on a hashing function of the multiple TSPs and a unique identifier associated with the contending UE.

At action 812, the UE may receive a COT region indicator from the UE 115i via COT-SI. The shared COT may be divided into one, two, three, four, or more COT sharing regions. Each of the COT sharing regions may be used by one or more COT sharing UEs (e.g., a COT responder) to transmit a sidelink communication. Each of the COT sharing regions may be associated with a different lookup table mapping a TSP index to TSP(s), a CPAC, an LBT category type, and a CPE. The UE 115j may receive a lookup table associated with one or more of the COT regions.

At action 814, the UE 115j may perform an LBT according to the LBT category type determined by the lookup table received at action 812. The UE 115j may perform the LBT in the COT region associated with the lookup table.

At action 816, the UE 115j may transmit a sidelink communication to the UE 115i starting at the TSP in the COT region associated with the lookup table based on a successful LBT procedure at action 814. If the LBT is successful at action 814, the first UE may start transmitting in the COT region during the CPE between the TSP and the slot boundary (e.g., the boundary between the end of symbol 13 and symbol 0 of the next slot).

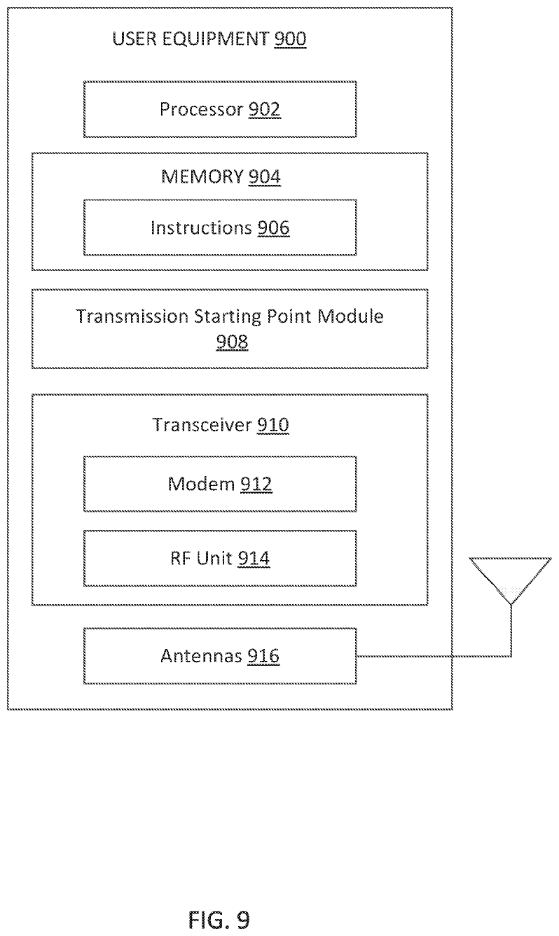

FIG. 9 is a block diagram of an exemplary UE 900 according to some aspects of the present disclosure. The UE 900 may be the UE 115 in the network 100, 200, or 300 as discussed above. As shown, the UE 900 may include a processor 902, a memory 904, a transmission starting point module 908, a transceiver 910 including a modem subsystem 912 and a radio frequency (RF) unit 914, and one or more antennas 916.

These elements may be coupled with each other and in direct or indirect communication with each other, for example via one or more buses.

The processor 902 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 904 includes a non-transitory computer-readable medium. The memory 904 may store instructions 906. The instructions 906 may include instructions that, when executed by the processor 902, cause the processor 902 to perform the operations described herein with reference to the UEs 115 in connection with aspects of the present disclosure, for example, aspects of FIGS. 3, 4A and 4B. Instructions 906 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The transmission starting point module 908 may be implemented via hardware, software, or combinations thereof. For example, the transmission starting point module 908 may be implemented as a processor, circuit, and/or instructions 906 stored in the memory 904 and executed by the processor 902. In some aspects, the transmission starting point module 908 may implement the aspects of FIGS. 3-8. For example, the transmission starting point module 908 may receive an indicator from a second UE indicating one or more transmission starting points. The transmission starting point module 908 may transmit, during a shared channel occupancy time (COT), a sidelink communication at a first transmission starting point of the one or more transmission starting points. The first transmission starting point may be based on a priority associated with the sidelink communication.

As shown, the transceiver 910 may include the modem subsystem 912 and the RF unit 914. The transceiver 910 can be configured to communicate bi-directionally with other devices, such as the BSs 105 and/or the UEs 115. The modem subsystem 912 may be configured to modulate and/or encode the data from the memory 904 and the according to a modulation and coding scheme (MCS), e.g., a low-density parity check (LDPC) coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or a BS 105. The RF unit 914 may be further configured to perform analog beamforming in conjunction with the digital beamforming. Although shown as integrated together in transceiver 910, the modem subsystem 912 and the RF unit 914 may be separate devices that are coupled together to enable the UE 900 to communicate with other devices.

The RF unit 914 may provide the modulated and/or processed data, e.g. data packets (or, more generally, data messages that may contain one or more data packets and other information), to the antennas 916 for transmission to one or more other devices. The antennas 916 may further receive data messages transmitted from other devices. The antennas 916 may provide the received data messages for processing and/or demodulation at the transceiver 910. The antennas 916 may include multiple antennas of similar or different designs in order to sustain multiple transmission links. The RF unit 914 may configure the antennas 916.

In some instances, the UE 900 can include multiple transceivers 910 implementing different RATs (e.g., NR and LTE). In some instances, the UE 900 can include a single transceiver 910 implementing multiple RATs (e.g., NR and LTE). In some instances, the transceiver 910 can include various components, where different combinations of components can implement RATs.

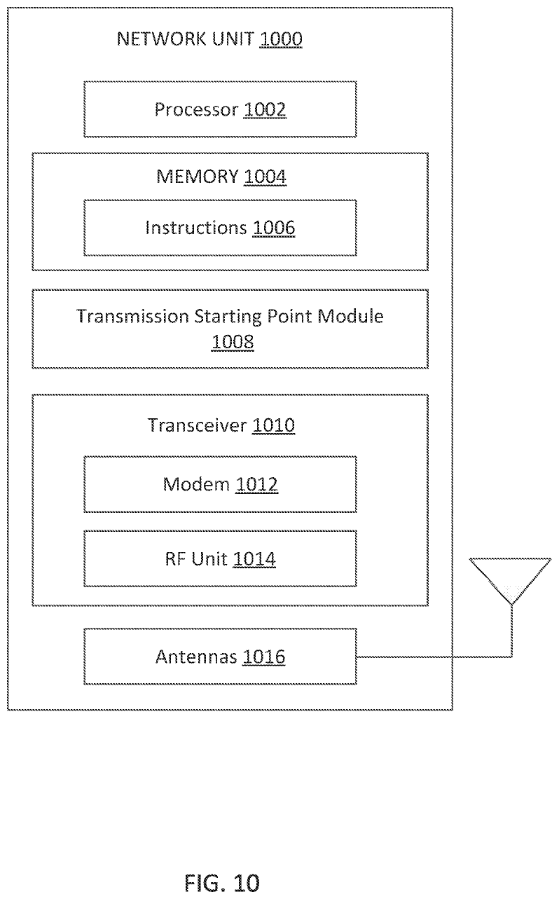

FIG. 10 is a block diagram of an exemplary network unit 1000 according to some aspects of the present disclosure. The network unit 1000 may be the BS 105, the CU 210, the DU 230, or the RU 240, as discussed above. As shown, the network unit 1000 may include a processor 1002, a memory 1004, a transmission starting point module 1008, a transceiver 1010 including a modem subsystem 1012 and a RF unit 1014, and one or more antennas 1016. These elements may be coupled with each other and in direct or indirect communication with each other, for example via one or more buses.

The processor 1002 may have various features as a specific-type processor. For example, these may include a CPU, a DSP, an ASIC, a controller, a FPGA device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1004 may include a non-transitory computer-readable medium. The memory 1004 may store instructions 1006. The instructions 1006 may include instructions that, when executed by the processor 1002, cause the processor 1002 to perform operations described herein, for example, aspects of FIGS. 3-8. Instructions 1006 may also be referred to as code, which may be interpreted broadly to include any type of computer-readable statement(s).

The transmission starting point module 1008 may be implemented via hardware, software, or combinations thereof. For example, the transmission starting point module 1008 may be implemented as a processor, circuit, and/or instructions 1006 stored in the memory 1004 and executed by the processor 1002.

In some aspects, the transmission starting point module 1008 may implement the aspects of FIGS. 3-8. For example, the transmission starting point module 1008 may transmit, to a user equipment (UE), an indicator indicating one or more transmission starting points for a shared COT. Additionally or alternatively, the transmission starting point module 1008 can be implemented in any combination of hardware and software, and may, in some implementations, involve, for example, processor 1002, memory 1004, instructions 1006, transceiver 1010, and/or modem 1012.

As shown, the transceiver 1010 may include the modem subsystem 1012 and the RF unit 1014. The transceiver 1010 can be configured to communicate bi-directionally with other devices, such as the UEs 115 and/or 600. The modem subsystem 1012 may be configured to modulate and/or encode data according to a MCS, e.g., a LDPC coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data from the modem subsystem 1012 (on outbound transmissions) or of transmissions originating from another source such as a UE 115 or UE 600. The RF unit 1014 may be further configured to perform analog beamforming in conjunction with the digital beamforming. Although shown as integrated together in transceiver 1010, the modem subsystem 1012 and/or the RF unit 1014 may be separate devices that are coupled together at the network unit 1000 to enable the network unit 1000 to communicate with other devices.

The RF unit 1014 may provide the modulated and/or processed data, e.g. data packets (or, more generally, data messages that may contain one or more data packets and other information), to the antennas 1016 for transmission to one or more other devices. This may include, for example, a configuration indicating a plurality of sub-slots within a slot according to aspects of the present disclosure. The antennas 1016 may further receive data messages transmitted from other devices and provide the received data messages for processing and/or demodulation at the transceiver 1010. The antennas 1016 may include multiple antennas of similar or different designs in order to sustain multiple transmission links.

In some instances, the network unit 1000 can include multiple transceivers 1010 implementing different RATs (e.g., NR and LTE). In some instances, the network unit 1000 can include a single transceiver 1010 implementing multiple RATs (e.g., NR and LTE). In some instances, the transceiver 1010 can include various components, where different combinations of components can implement RATs.

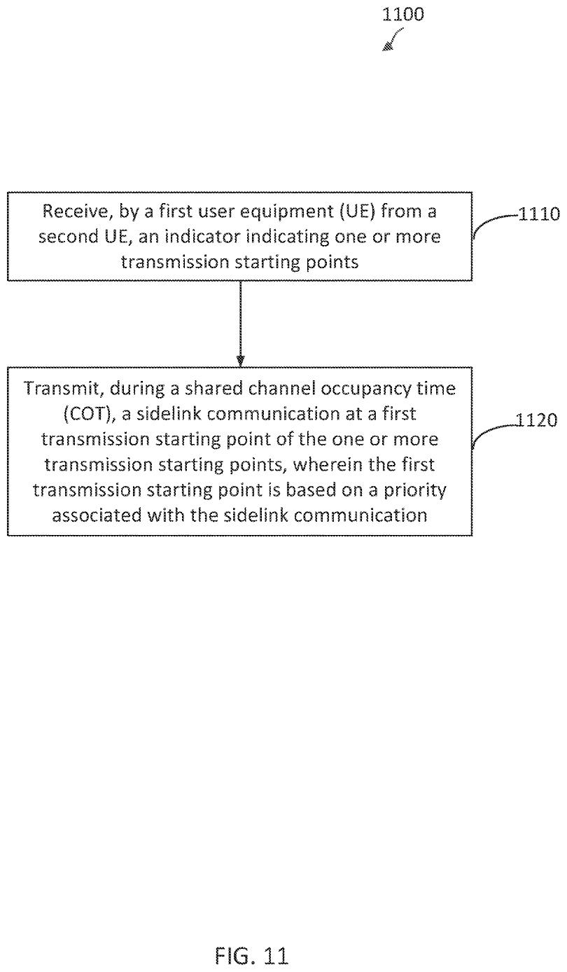

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the actions. For example, a wireless communication device, such as the UE 115 or the UE 900, may utilize one or more components, such as the processor 902, the memory 904, the transmission starting point module 908, the transceiver 910, the modem 912, and the one or more antennas 916 to execute aspects of method 1100. The method 1100 may employ similar mechanisms as in the networks 100 and 200 and the aspects and actions described with respect to FIGS. 3-8. As illustrated, the method 1100 includes a number of enumerated actions, but the method 1100 may include additional actions before, after, and in between the enumerated actions. In some aspects, one or more of the enumerated actions may be omitted or performed in a different order.

At action 1110, the method 1100 includes a first UE (e.g., a sidelink UE, the UE 115, or the UE 600) receiving an indicator from a second UE (e.g., a sidelink UE, the UE 115, or the UE 600) indicating one or more transmission starting points. In this regard, the first UE may receive the indicator via a sidelink radio resource control (RRC) communication, sidelink control information (e.g., SCI-1, SCI-2), a channel occupancy time (COT) structure indicator (COT-SI), COT sharing information, a physical sidelink shared channel (PSSCH) communication, a physical sidelink control channel (PSCCH) communication, and/or other suitable communication. Additionally or alternatively, the first sidelink UE may receive the indicator from a network unit (e.g., the BS 105, the RU 240, the DU 230, the CU 210, and/or the network unit 1000) via a RRC communication, downlink control information (DCI), a medium access control-control element (MAC-CE), a physical downlink shared channel (PDSCH) communication, a physical downlink control channel (PDCCH) communication, and/or other suitable communication. In some aspects, the transmission starting point(s) may correspond to a starting point of a portion of a shared COT that may be utilized by the first UE for sidelink communications.

In some aspects, the indicator indicating the transmission starting points (TSPs) may include a lookup table mapping a TSP index to TSP(s), a channel access priority class (CAPC), an LBT category type, and/or a CPE. For example, the lookup table may include one or more TSP entries that corresponds to a CAPC. In some aspects, each of the TSP(s) may correspond to a different CAPC. In some aspects, multiple TSPs may correspond to the same CAPC. In some aspects, the same TSP may correspond to multiple CAPCs.

The CAPC may be associated with a sidelink transmission. The transmission may be a transport block transmitted via a PSSCH. The CAPC associated with the sidelink communication may indicate the priority (e.g., latency budget) of the sidelink communication. In some aspects, a higher CAPC value (e.g., 4) may indicate a lower priority level while a lower CAPC value (e.g., 1) may indicate a higher priority level.

In some aspects, the indicator may further indicate a listen-before-talk (LBT) category and/or a LBT category type. The category may include a category 1 LBT, a category 2 LBT, a category 3 LBT, and/or a category 4 LBT. The indicator may further indicate the category type. For example, the category type may include a category type 2A, type 2B, and/or type 2C. The first UE may perform an LBT according to the category and category type to gain access to the COT in an unlicensed frequency spectrum.

In some aspects, the indicator may further indicate a cyclic prefix extension (CPE) length. The first UE may transmit a CPE prior to transmitting a sidelink transmission to facilitate alignment of orthogonal frequency division multiplexing (OFDM) symbols and retain the shared COT by blocking other UEs contending for the shared COT.

In some aspects, the number of TSPs may be based on a subchannel carrier spacing (SCS) associated with the sidelink communication. For example, a lower SCS may correspond to a higher number of TSPs while a higher SCS may correspond to a lower number of TSPs. As a non-limiting example, when the SCS is 15 KHz, the number of TSPs may be 8. As another non-limiting example, when the SCS is 30 KHz, the number of TSPs may be 4. As another non-limiting example, when the SCS is 60 KHz, the number of TSPs may be 2.

In some aspects, the indicator may include one or more codepoint fields. The UE may receive the indicator in one or more codepoint fields via COT structure information (COT-SI), COT sharing information, and/or SCI (e.g., SCI-1, SCI-2). The indicator indicating the TSP(s) may include a first codepoint field indicating a number of TSP(s), a second codepoint field may indicate a location of the TSP(s), and a third codepoint field may map the TSP(s) to the CAPC associated with the sidelink communication. The number of codepoints in each of the first, second, and third codepoints may vary (e.g., a flexible number of codepoints in each codepoint field). However, the total number of bits in the indicator may be fixed and the sum of the first, second, and third codepoint fields may equal the fixed number of bits in the indicator. In some aspects, the first codepoint field may be based on the SCS associated with the sidelink communication. For example, when the SCS is 15 KHz, the first codepoint field may include 3 bits indicating up to 8 TSPs. When the SCS is 30 KHz, the first codepoint field may include 2 bits indicating up to 4 TSPs. When the SCS is 60 KHz, the first codepoint field may include 1 bit indicating up to 2 TSPs.

In some aspects, the second codepoint field may be based on the number of TSPs in the first codepoint field. In some aspects, the third codepoint field may be based on the number of bits in the first codepoint field (e.g., the number of TSPs which is based on the SCS) and a CAPC associated with the second UE (e.g., a CAPC associated with a sidelink communication transmitted by the COT initiator).

In some aspects, the COT duration may be divided into multiple COT sharing regions. The COT duration may be divided into one, two, three, four, or more COT sharing regions. Each of the regions may include a number of slots. The COT sharing regions may be overlapping or non-overlapping in time. Each of the COT sharing regions may be used by one or more COT sharing UEs (e.g., a COT responder) to transmit a sidelink communication. Each of the COT sharing regions may be associated with a different indicator (e.g., the indicator received at action 1110) indicating the TSP(s). For example, each of the COT sharing regions may be associated with a lookup table mapping a TSP index to TSP(s), a CPAC, an LBT category type, and a CPE. In some aspects, the second UE (e.g., the COT initiator) may transmit a single indicator indicating the lookup tables for each of the regions. In this regard, the single indicator may be transmitted via COT structure information (COT-SI), COT sharing information, and/or SCI (e.g., SCI-1, SCI-2). In some aspects, the second UE (e.g., the COT initiator) may transmit multiple indicators indicating the lookup tables for each of the regions. In this regard, each of the multiple indicators may be transmitted via COT structure information (COT-SI), COT sharing information, and/or SCI (e.g., SCI-1, SCI-2). The second UE may transmit the multiple indicators in different time resources (e.g., different slots) and/or in different frequency resources (e.g., different subchannels).

In some aspects, the multiple COT sharing regions may be non-overlapping and contiguous. In this case, the indicator indicating the multiple lookup tables may include a starting point for each of the regions and a single ending point for the last region. In this way, the first UE and other responding UEs may interpret the ending point of a COT sharing region as the same as the starting point of the next contiguous COT sharing region. In some aspects, the ending point of the COT sharing regions may be the end of the maximum COT (MCOT) duration.

At action 1120, the method 1100 includes the first UE transmitting a communication at a first TSP of the one or more TSPs. The first UE may transmit the communication during the shared COT. In this regard, the communication may include a sidelink communication (e.g., a PSSCH, a PSCCH, SCI, or other sidelink communication). In some aspects, the communication may include a Uu communication (e.g., a PUSCH, a PUCCH, UCI, or other sidelink communication). The first UE may start transmitting the communication at a TSP based on a CAPC associated with the communication. The indicator (e.g., the lookup table) received at action 1110 may map the TSP to the CAPC associated with the communication.

In some aspects, the first UE may perform an LBT procedure to acquire the shared COT during which the first UE is permitted to transmit the communication in an unlicensed channel. For example, prior to gaining access to and transmitting over the unlicensed channel, the first UE may perform the LBT procedure according to the LBT category type indicated in the indicator received at action 1110 to contend for access to the unlicensed channel. In some aspects, the LBT procedure may include a clear channel assessment (CCA) procedure that the first UE performs to determine whether the unlicensed channel is available (e.g., unoccupied by other transmitters). In particular, the first UE may detect an energy level on the unlicensed channel, and the LBT procedure may be deemed successful if the energy level on the unlicensed channel satisfies (e.g., is less than or equal to) a threshold. In some aspects, the first UE may gain access to the unlicensed channel to acquire the shared COT during which the first UE may perform transmissions without performing additional LBT operations. Additionally, or alternatively, in cases where the energy level detected on the unlicensed channel fails to satisfy the threshold (e.g., is greater than or equal to the threshold), the first UE may perform the LBT procedure again and acquire the shared COT at a later time.

The first UE may perform the LBT in slot symbol 13 (e.g., the gap symbol) just prior to the TSP that corresponds to the CAPC of the communication the first UE intends to transmit. If the LBT is successful, the first UE may transmit during the CPE between the TSP and the slot boundary (e.g., the boundary between the end of symbol 13 and symbol 0 of the next slot). By transmitting during the CPE starting at the TSP, the first UE may block other UEs contending for the shared COT. A sidelink communication having a high priority (e.g., lower CAPC value) may be assigned an earlier TSP than a sidelink communication having a lower priority (e.g., higher CAPC value). In this way, a UE having a high priority communication to transmit may be assigned an earlier TSP thereby blocking other COT sharing UEs having lower priority communications from gaining the shared COT. When more than one UE has a high priority communication to transmit (e.g., multiple UEs having the same CAPC value), the UEs may compete for an earlier TSP based on a random selection process. The random TSP selection process may provide a random chance for the contending UEs to be assigned the earlier TSP. In this regard, each of the contending UEs may select a TSP based on a hashing function of the multiple TSPs. For example, each of the contending UEs may select a TSP based on a hashing function of the multiple TSPs and a unique identifier associated with the contending UE.

In some aspects, the first UE may share the COT with other UEs (e.g., other sidelink UEs) based on frequency division multiplexing (FDM) of the shared COT resources. For example, each of the UEs contending for the shared COT may be assigned a set of unique frequency ranges (e.g., subchannels) to transmit in. The number of subchannels assigned to each UE may be based on a size of the communication to be transmitted (e.g., the TB size). In FDM mode, each of the UEs may be assigned a same TSP allowing communications of the same priority to be transmitted at the same time but in different frequency subchannels. The frequency subchannels may include one or more ranges of frequency subchannels and/or one or more frequency subchannel interlaces. Prior to transmitting, each of the UEs contending for the shared COT may perform the LBT type indicated by the indicator received at action 1110 in their respectively assigned subchannels.

In some aspects, the first UE may share the COT with other UEs based on time division multiplexing (TDM) of the shared COT resources. For example, each of the UEs contending for the shared COT may be assigned a TSP based on the CAPC of the communication to be transmitted. In TDM mode, each of the UEs may be assigned a TSP based on CAPC allowing communications of a higher priority to be transmitted before communications of a lower priority. Prior to transmitting, each of the UEs contending for the shared COT may perform the LBT type indicated by the indicator received at action 1110 before their respectively assigned TSP.

In some aspects, the first UE may only transmit in the shared COT when a CPAC of the first UE's intended communication has an equal or lower value than a CAPC of a communication transmitted by the second UE (e.g., the COT initiator). In other words, the UE intending to share the COT may only transmit in the COT when a priority associated with the communication it intends to transmit is equal to or higher than the communication transmitted by the COT initiating UE.

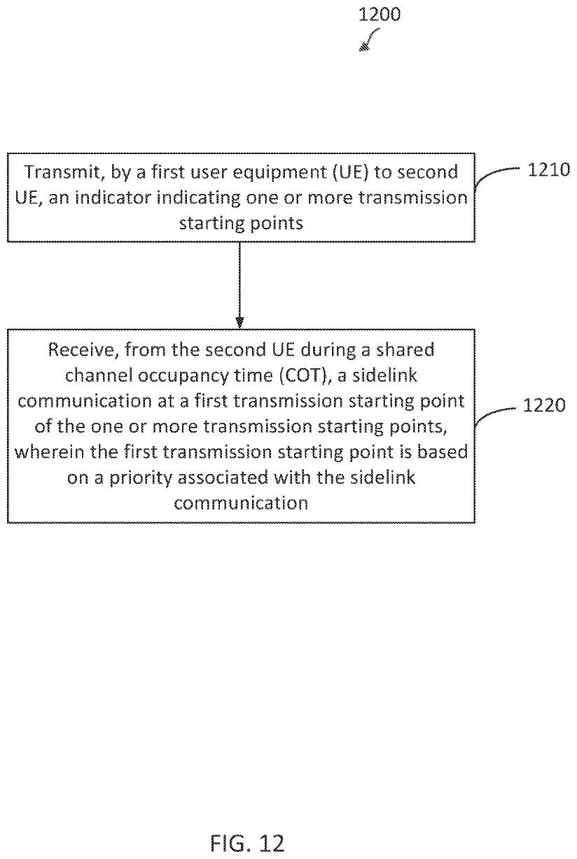

FIG. 12 is a flow diagram of a communication method 1200 according to some aspects of the present disclosure. Aspects of the method 1200 can be executed by a computing device (e.g., a processor, processing circuit, and/or other suitable component) of a wireless communication device or other suitable means for performing the actions. For example, a wireless communication device, such as the UE 115 or the UE 900, may utilize one or more components, such as the processor 902, the memory 904, the transmission starting point module 908, the transceiver 910, the modem 912, and the one or more antennas 916 to execute aspects of method 1200. The method 1200 may employ similar mechanisms as in the networks 100 and 200 and the aspects and actions described with respect to FIGS. 3-8. As illustrated, the method 1200 includes a number of enumerated actions, but the method 1200 may include additional actions before, after, and in between the enumerated actions. In some aspects, one or more of the enumerated actions may be omitted or performed in a different order.

At action 1210, the method 1200 includes a first UE (e.g., a COT initiating UE, a sidelink UE, the UE 115, or the UE 600) transmitting an indicator to a second UE (e.g., a COT responding UE, a sidelink UE, the UE 115, or the UE 600) indicating one or more transmission starting points. In this regard, the first UE may transmit the indicator via a sidelink radio resource control (RRC) communication, sidelink control information (e.g., SCI-1, SCI-2), a channel occupancy time (COT) structure indicator (COT-SI), COT sharing information, a physical sidelink shared channel (PSSCH) communication, a physical sidelink control channel (PSCCH) communication, and/or other suitable communication. Additionally or alternatively, the second sidelink UE may receive the indicator from a network unit (e.g., the BS 105, the RU 240, the DU 230, the CU 210, and/or the network unit 1000) via a RRC communication, downlink control information (DCI), a medium access control-control element (MAC-CE), a physical downlink shared channel (PDSCH) communication, a physical downlink control channel (PDCCH) communication, and/or other suitable communication. In some aspects, the transmission starting point(s) may correspond to a starting point of a portion of a shared COT that may be utilized by the second UE for sidelink communications.

In some aspects, the indicator indicating the transmission starting points (TSPs) may include a lookup table mapping a TSP index to TSP(s), a channel access priority class (CAPC), an LBT category type, and/or a CPE. For example, the lookup table may include one or more TSP entries that corresponds to a CAPC. In some aspects, each of the TSP(s) may correspond to a different CAPC. In some aspects, multiple TSPs may correspond to the same CAPC. In some aspects, the same TSP may correspond to multiple CAPCs.

The CAPC may be associated with a sidelink transmission. The transmission may be a transport block transmitted by the second UE via a PSSCH. The CAPC associated with the sidelink communication may indicate the priority (e.g., latency budget) of the sidelink communication. In some aspects, a higher CAPC value (e.g., 4) may indicate a lower priority level while a lower CAPC value (e.g., 1) may indicate a higher priority level.

In some aspects, the indicator may further indicate a listen-before-talk (LBT) category and/or a LBT category type. The category may include a category 1 LBT, a category 2 LBT, a category 3 LBT, and/or a category 4 LBT. The indicator may further indicate the category type. For example, the category type may include a category type 2A, type 2B, and/or type 2C. The second UE may perform an LBT according to the category and category type to gain access to the COT in an unlicensed frequency spectrum.

In some aspects, the indicator may further indicate a cyclic prefix extension (CPE) length. The second UE may transmit a CPE prior to transmitting a sidelink transmission to facilitate alignment of orthogonal frequency division multiplexing (OFDM) symbols and retain the shared COT by blocking other UEs contending for the shared COT.

In some aspects, the number of TSPs may be based on a subchannel carrier spacing (SCS) associated with the sidelink communication. For example, a lower SCS may correspond to a higher number of TSPs while a higher SCS may correspond to a lower number of TSPs. As a non-limiting example, when the SCS is 15 KHz, the number of TSPs may be 8. As another non-limiting example, when the SCS is 30 KHz, the number of TSPs may be 4. As another non-limiting example, when the SCS is 60 KHz, the number of TSPs may be 2.

In some aspects, the indicator may include one or more codepoint fields. The first UE may transmit the indicator in one or more codepoint fields via COT structure information (COT-SI), COT sharing information, and/or SCI (e.g., SCI-1, SCI-2). The indicator indicating the TSP(s) may include a first codepoint field indicating a number of TSP(s), a second codepoint field may indicate a location of the TSP(s), and a third codepoint field may map the TSP(s) to the CAPC associated with the sidelink communication. The number of codepoints in each of the first, second, and third codepoints may vary (e.g., a flexible number of codepoints in each codepoint field). However, the total number of bits in the indicator may be fixed and the sum of the first, second, and third codepoint fields may equal the fixed number of bits in the indicator. In some aspects, the first codepoint field may be based on the SCS associated with the sidelink communication. For example, when the SCS is 15 KHz, the first codepoint field may include 3 bits indicating up to 8 TSPs. When the SCS is 30 KHz, the first codepoint field may include 2 bits indicating up to 4 TSPs. When the SCS is 60 KHz, the first codepoint field may include 1 bit indicating up to 2 TSPs.

In some aspects, the second codepoint field may be based on the number of TSPs in the first codepoint field. In some aspects, the third codepoint field may be based on the number of bits in the first codepoint field (e.g., the number of TSPs which is based on the SCS) and a CAPC associated with the first UE (e.g., a CAPC associated with a sidelink communication transmitted by the COT initiator).

In some aspects, the COT duration may be divided into multiple COT sharing regions. The COT duration may be divided into one, two, three, four, or more COT sharing regions. Each of the regions may include a number of slots. The COT sharing regions may be overlapping or non-overlapping in time. Each of the COT sharing regions may be used by one or more COT sharing UEs (e.g., a COT responder) to transmit a sidelink communication. Each of the COT sharing regions may be associated with a different indicator (e.g., the indicator transmitted by the first UE at action 1210) indicating the TSP(s). For example, each of the COT sharing regions may be associated with a lookup table mapping a TSP index to TSP(s), a CPAC, an LBT category type, and a CPE. In some aspects, the first UE (e.g., the COT initiator) may transmit a single indicator indicating the lookup tables for each of the regions. In this regard, the single indicator may be transmitted via COT structure information (COT-SI), COT sharing information, and/or SCI (e.g., SCI-1, SCI-2). In some aspects, the first UE (e.g., the COT initiator) may transmit multiple indicators indicating the lookup tables for each of the regions. In this regard, each of the multiple indicators may be transmitted via COT structure information (COT-SI), COT sharing information, and/or SCI (e.g., SCI-1, SCI-2). The first UE may transmit the multiple indicators in different time resources (e.g., different slots) and/or in different frequency resources (e.g., different subchannels).

In some aspects, the multiple COT sharing regions may be non-overlapping and contiguous. In this case, the indicator indicating the multiple lookup tables may include a starting point for each of the regions and a single ending point for the last region. In this way, the second UE and other responding UEs may interpret the ending point of a COT sharing region as the same as the starting point of the next contiguous COT sharing region. In some aspects, the ending point of the COT sharing regions may be the end of the maximum COT (MCOT) duration.

At action 1220, the method 1200 includes the first UE receiving a communication starting at a first TSP of the one or more TSPs. The first UE may receive the communication during the shared COT. In this regard, the communication may include a sidelink communication (e.g., a PSSCH, a PSCCH, SCI, or other sidelink communication). The second UE may start transmitting the communication at a TSP based on a CAPC associated with the communication. The indicator (e.g., the lookup table) transmitted at action 1210 may map the TSP to the CAPC associated with the sidelink communication.

In some aspects, the second UE may perform an LBT procedure to acquire the shared COT during which the second UE is permitted to transmit the communication in an unlicensed channel. For example, prior to gaining access to and transmitting over the unlicensed channel, the second UE may perform the LBT procedure according to the LBT category type indicated in the indicator transmitted by the first UE at action 1210 to contend for access to the unlicensed channel. In some aspects, the LBT procedure may include a clear channel assessment (CCA) procedure that the second UE performs to determine whether the unlicensed channel is available (e.g., unoccupied by other transmitters). In particular, the second UE may detect an energy level on the unlicensed channel, and the LBT procedure may be deemed successful if the energy level on the unlicensed channel satisfies (e.g., is less than or equal to) a threshold. In some aspects, the second UE may gain access to the unlicensed channel to acquire the shared COT during which the second UE may perform transmissions without performing additional LBT operations. Additionally, or alternatively, in cases where the energy level detected on the unlicensed channel fails to satisfy the threshold (e.g., is greater than or equal to the threshold), the second UE may perform the LBT procedure again and acquire the shared COT at a later time.

The second UE may perform the LBT in slot symbol 13 (e.g., the gap symbol) just prior to the TSP that corresponds to the CAPC of the communication the second UE intends to transmit. If the LBT is successful, the second UE may transmit during the CPE between the TSP and the slot boundary (e.g., the boundary between the end of symbol 13 and symbol 0 of the next slot). By transmitting during the CPE starting at the TSP, the second UE may block other UEs contending for the shared COT. A sidelink communication having a high priority (e.g., lower CAPC value) may be assigned an earlier TSP than a sidelink communication having a lower priority (e.g., higher CAPC value). In this way, a UE having a high priority communication to transmit may be assigned an earlier TSP thereby blocking other COT sharing UEs having lower priority communications from gaining the shared COT. When more than one UE has a high priority communication to transmit (e.g., multiple UEs having the same CAPC value), the UEs may compete for an earlier TSP based on a random selection process. The random TSP selection process may provide a random chance for the contending UEs to be assigned the earlier TSP. In this regard, each of the contending UEs may select a TSP based on a hashing function of the multiple TSPs. For example, each of the contending UEs may select a TSP based on a hashing function of the multiple TSPs and a unique identifier associated with the contending UE.

In some aspects, the second UE may share the COT with other UEs (e.g., other sidelink UEs) based on frequency division multiplexing (FDM) of the shared COT resources. For example, each of the UEs contending for the shared COT may be assigned a set of unique frequency ranges (e.g., subchannels) to transmit in. The number of subchannels assigned to each UE may be based on a size of the communication to be transmitted (e.g., the TB size). In FDM mode, each of the UEs may be assigned a same TSP allowing communications of the same priority to be transmitted at the same time but in different frequency subchannels. The frequency subchannels may include one or more ranges of frequency subchannels and/or one or more frequency subchannel interlaces. Prior to transmitting, each of the UEs contending for the shared COT may perform the LBT type indicated by the indicator transmitted by the first UE at action 1210 in their respectively assigned subchannels.

In some aspects, the second UE may share the COT with other UEs based on time division multiplexing (TDM) of the shared COT resources. For example, each of the UEs contending for the shared COT may be assigned a TSP based on the CAPC of the communication to be transmitted. In TDM mode, each of the UEs may be assigned a TSP based on a CAPC allowing communications of a higher priority to be transmitted before communications of a lower priority. Prior to transmitting, each of the UEs contending for the shared COT may perform the LBT type indicated by the indicator transmitted by the first UE at action 1210 before their respectively assigned TSP.

In some aspects, the second UE may only transmit in the shared COT when a CPAC of the second UE's intended communication has an equal or lower value than a CAPC of a communication transmitted by the first UE (e.g., the COT initiator). In other words, the UE intending to share the COT may only transmit in the COT when a priority associated with the communication it intends to transmit is equal to or higher than the communication transmitted by the COT initiating UE.

Further aspects of the present disclosure include the following:

Aspect 1 includes a method of wireless communication performed by a user equipment (UE), the method comprising receiving, from a second UE, an indicator indicating one or more transmission starting points; and transmitting, during a shared channel occupancy time (COT), a sidelink communication at a first transmission starting point of the one or more transmission starting points, wherein the first transmission starting point is based on a priority associated with the sidelink communication.

Aspect 2 includes the method of aspect 1, wherein the priority associated with the sidelink communication comprises a channel access priority class (CAPC) associated with the sidelink communication.

Aspect 3 includes the method of any of aspects 1-2, wherein the indicator indicating the one or more transmission starting points comprises a lookup table mapping the one or more transmission starting points to a channel access priority class (CAPC).

Aspect 4 includes the method of any of aspects 1-3, wherein the lookup table maps multiple starting points of the one or more transmission starting points to a same CAPC.

Aspect 5 includes the method of any of aspects 1-4, wherein the first transmission starting point is based on a hashing function of the multiple starting points.

Aspect 6 includes the method of any of aspects 1-5, wherein the indicator further indicates at least one of a listen-before-talk (LBT) category type or a cyclic prefix extension.

Aspect 7 includes the method of any of aspects 1-6, further comprising performing an LBT procedure based on the LBT category type, wherein the transmitting the sidelink communication comprises transmitting the sidelink communication based on the LBT procedure being successful.

Aspect 8 includes the method of any of aspects 1-7, wherein a number of the one or more transmission starting points is based on a subchannel carrier spacing (SCS) associated with the sidelink communication.

Aspect 9 includes the method of any of aspects 1-8, wherein the transmitting the sidelink communication comprises transmitting the sidelink communication in a time division multiplex (TDM) with one or more sidelink communications associated with one or more other UEs.

Aspect 10 includes the method of any of aspects 1-9, wherein the TDM is based on the priority associated with the sidelink communication.

Aspect 11 includes the method of any of aspects 1-10, wherein the transmitting the sidelink communication comprises transmitting the sidelink communication in a frequency division multiplex (FDM) with one or more sidelink communications associated with one or more other UEs.

Aspect 12 includes the method of any of aspects 1-11, wherein the priority associated with the sidelink communication is a same priority associated with the one or more sidelink communications associated with the one or more other UEs.

Aspect 13 includes the method of any of aspects 1-12, wherein the receiving the indicator indicating the one or more transmission starting points comprises at least one of receiving, from a network unit, the indicator in a radio resource control (RRC) communication; or receiving, from the second UE, the indicator in a sidelink RRC communication.

Aspect 14 includes the method of any of aspects 1-13, wherein the indicator indicating the one or more transmission starting points comprises a first codepoint field indicating a number of transmission starting points; a second codepoint field indicating a location of the transmission starting points; and a third codepoint field mapping the transmission starting points to the priority associated with the sidelink communication.

Aspect 15 includes the method of any of aspects 1-14, wherein the first codepoint field is based on a subcarrier spacing (SCS) associated with the sidelink communication.

Aspect 16 includes the method of any of aspects 1-15, wherein the second codepoint field is based on the number of transmission starting points in the first codepoint field.

Aspect 17 includes the method of any of aspects 1-16, wherein the third codepoint field is based on the number of transmission starting points and a channel access priority class (CAPC) associated with the second UE.

Aspect 18 includes the method of any of aspects 1-17, wherein the receiving the indicator indicating the one or more transmission starting points comprises receiving the indicator in codepoints in the SCI.

Aspect 19 includes the method of any of aspects 1-18, wherein the receiving the indicator indicating the one or more transmission starting points comprises receiving the indicator in codepoints in the SCI.

Aspect 20 includes the method of any of aspects 1-19, wherein a number of the codepoints in the SCI is based on a subchannel carrier spacing (SCS) associated with the sidelink communication.

Aspect 21 includes the method of any of aspects 1-20, wherein the receiving the indicator indicating the one or more transmission starting points comprises receiving, from the second UE, the indicator in COT structure information (COT-SI).

Aspect 22 includes the method of any of aspects 1-21, further comprising receiving, from the second UE, one or more COT indicators indicating multiple COT regions within the COT; and receiving, from the second UE, one or more indicators indicating one or more transmission starting points associated with each of the multiple COT regions, wherein the multiple indicators includes the indicator.

Aspect 23 includes the method of any of aspects 1-22, wherein the one or more COT indicators comprises at least one of COT structure information (COT-SI) indicators or COT sharing indicators.

Aspect 24 includes the method of any of aspects 1-23, further comprising receiving, from the second UE, a second sidelink communication, wherein the transmitting the sidelink communication is based on the priority associated with the sidelink communication being equal to or higher than a priority associated with the second sidelink communication.

Aspect 25 includes a non-transitory computer-readable medium storing one or more instructions for wireless communication, the one or more instructions comprising one or more instructions that, when executed by one or more processors of a UE, cause the UE to perform any one of aspects 1-24.

Aspect 26 includes a user equipment (UE) comprising one or more means to perform any one or more of aspects 1-24.

Aspect 27 includes a user equipment (UE) comprising a memory; a transceiver; and at least one processor coupled to the memory and the transceiver, wherein the UE is configured to perform any one or more of aspects 1-24.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communications performed by a first user equipment (UE), the method comprising:
receiving, from a second UE, an indicator indicating one or more transmission starting points; and
transmitting, during a shared channel occupancy time (COT), a sidelink communication at a first transmission starting point of the one or more transmission starting points, wherein the first transmission starting point is based on a priority associated with the sidelink communication.

2. The method of claim 1, wherein:
the priority associated with the sidelink communication comprises a channel access priority class (CAPC) associated with the sidelink communication.

3. The method of claim 1, wherein the indicator indicating the one or more transmission starting points comprises a lookup table mapping the one or more transmission starting points to a channel access priority class (CAPC),
wherein the lookup table maps multiple starting points of the one or more transmission starting points to a same CAPC, and
wherein the first transmission starting point is based on a hashing function of the multiple starting points.

4. The method of claim 1, wherein the transmitting the sidelink communication comprises transmitting the sidelink communication in a time division multiplex (TDM) with one or more sidelink communications associated with one or more other UEs, and
wherein the TDM is based on the priority associated with the sidelink communication.

5. The method of claim 1, wherein the transmitting the sidelink communication comprises transmitting the sidelink communication in a frequency division multiplex (FDM) with one or more sidelink communications associated with one or more other UEs, and
wherein the priority associated with the sidelink communication is a same priority associated with the one or more sidelink communications associated with the one or more other UE.

6. The method of claim 1, wherein the indicator indicating the one or more transmission starting points comprises:
a first codepoint field indicating a number of transmission starting points;
a second codepoint field indicating a location of the transmission starting points; and
a third codepoint field mapping the transmission starting points to the priority associated with the sidelink communication,
wherein the first codepoint field is based on a subcarrier spacing (SCS) associated with the sidelink communication,
wherein the second codepoint field is based on the number of transmission starting points in the first codepoint field, and
wherein the third codepoint field is based on the number of transmission starting points and a channel access priority class (CAPC) associated with the second UE.

7. The method of claim 1, wherein the receiving the indicator indicating the one or more transmission starting points comprises receiving, from the second UE, the indicator in sidelink control information (SCI),
wherein the receiving the indicator indicating the one or more transmission starting points comprises receiving the indicator in codepoints in the SCI, and
wherein a number of the codepoints in the SCI is based on a subchannel carrier spacing (SCS) associated with the sidelink communication.

8. The method of claim 1, further comprising:
receiving, from the second UE, one or more COT indicators indicating multiple COT regions within the COT; and
receiving, from the second UE, one or more indicators indicating one or more transmission starting points associated with each of the multiple COT regions, wherein the multiple indicators includes the indicator,
wherein the one or more COT indicators comprises at least one of COT structure information (COT-SI) indicators or COT sharing indicators.

9. A method of wireless communications performed by a first user equipment (UE), the method comprising:
transmitting, to second UE, an indicator indicating one or more transmission starting points; and
receiving, from the second UE during a shared channel occupancy time (COT), a sidelink communication at a first transmission starting point of the one or more transmission starting points, wherein the first transmission starting point is based on a priority associated with the sidelink communication.

10. The method of claim 9, wherein:
the priority associated with the sidelink communication comprises a channel access priority class (CAPC) associated with the sidelink communication.

11. The method of claim 9, wherein the indicator indicating the one or more transmission starting points comprises a lookup table mapping the one or more transmission starting points to a channel access priority class (CAPC),
wherein the lookup table maps multiple starting points of the one or more transmission starting points to a same CAPC, and
wherein the first transmission starting point is based on a hashing function of the multiple starting points.

12. The method of claim 9, wherein the receiving the sidelink communication comprises receiving the sidelink communication in a time division multiplex (TDM) with one or more sidelink communications associated with one or more other UEs, and
wherein the TDM is based on the priority associated with the sidelink communication.

13. The method of claim 9, wherein the receiving the sidelink communication comprises receiving the sidelink communication in a frequency division multiplex (FDM) with one or more sidelink communications associated with one or more other UEs, and
wherein the priority associated with the sidelink communication is a same priority associated with the one or more sidelink communications associated with the one or more other UEs.

14. The method of claim 9, wherein the indicator indicating the one or more transmission starting points comprises:
a first codepoint field indicating a number of transmission starting points;
a second codepoint field indicating a location of the transmission starting points; and
a third codepoint field mapping the transmission starting points to the priority associated with the sidelink communication,
wherein the first codepoint field is based on a subcarrier spacing (SCS) associated with the sidelink communication,
wherein the second codepoint field is based on the number of transmission starting points in the first codepoint field, and
wherein the third codepoint field is based on the number of transmission starting points and a channel access priority class (CAPC) associated with the first UE.

15. The method of claim 9, wherein the transmitting the indicator indicating the one or more transmission starting points comprises transmitting, to the second UE, the indicator in sidelink control information (SCI),
wherein the transmitting the indicator indicating the one or more transmission starting points comprises transmitting the indicator in codepoints in the SCI,
wherein a number of the codepoints in the SCI is based on a subchannel carrier spacing (SCS) associated with the sidelink communication, and
wherein the transmitting the indicator indicating the one or more transmission starting points comprises transmitting, to the second UE, the indicator in COT structure information (COT-SI).

16. A user equipment (UE) comprising:
a memory;
a transceiver; and
one or more processors coupled to the memory and the transceiver, the memory comprising instructions executable by the one or more processors individually or collectively to cause the UE to:
receive, from a second UE, an indicator indicating one or more transmission starting points; and
transmit, during a shared channel occupancy time (COT), a sidelink communication at a first transmission starting point of the one or more transmission starting points, wherein the first transmission starting point is based on a priority associated with the sidelink communication.

17. The UE of claim 16, wherein:
the priority associated with the sidelink communication comprises a channel access priority class (CAPC) associated with the sidelink communication.

18. The UE of claim 16, wherein the indicator indicating the one or more transmission starting points comprises a lookup table mapping the one or more transmission starting points to a channel access priority class (CAPC),
wherein the lookup table maps multiple starting points of the one or more transmission starting points to a same CAPC, and
wherein the first transmission starting point is based on a hashing function of the multiple starting points.

19. The UE of claim 16, wherein the one or more processors are further configured individually or collectively to cause the UE to transmit the sidelink communication in a time division multiplex (TDM) with one or more sidelink communications associated with one or more other UEs,
wherein the TDM is based on the priority associated with the sidelink communication.

20. The UE of claim 16, wherein the one or more processors are further configured individually or collectively to cause the UE to transmit the sidelink communication in a frequency division multiplex (FDM) with one or more sidelink communications associated with one or more other UEs,
wherein the priority associated with the sidelink communication is a same priority associated with the one or more sidelink communications associated with the one or more other UEs.

21. The UE of claim 16, wherein the indicator indicating the one or more transmission starting points comprises:
a first codepoint field indicating a number of transmission starting points;
a second codepoint field indicating a location of the transmission starting points; and
a third codepoint field mapping the transmission starting points to the priority associated with the sidelink communication,
wherein the first codepoint field is based on a subcarrier spacing (SCS) associated with the sidelink communication,
wherein the second codepoint field is based on the number of transmission starting points in the first codepoint field, and
wherein the third codepoint field is based on the number of transmission starting points and a channel access priority class (CAPC) associated with the second UE.

22. The UE of claim 16, wherein the one or more processors are further configured individually or collectively to cause the UE to receive, from the second UE, the indicator in sidelink control information (SCI),
wherein the UE is further configured to receive the indicator indicating the one or more transmission starting points in codepoints in the SCI, and
wherein a number of the codepoints in the SCI is based on a subchannel carrier spacing (SCS) associated with the sidelink communication.

23. The UE of claim 16, wherein the one or more processors are further configured individually or collectively to cause the UE to:
receive, from the second UE, one or more COT indicators indicating multiple COT regions within the COT; and
receive, from the second UE, one or more indicators indicating one or more transmission starting points associated with each of the multiple COT regions, wherein the multiple indicators includes the indicator,
wherein the one or more COT indicators comprises at least one of COT structure information (COT-SI) indicators or COT sharing indicators.

24. A user equipment (UE) comprising:
a memory;
a transceiver; and
one or more processors coupled to the memory and the transceiver, the memory comprising instructions executable by the one or more processors individually or collectively to cause the UE to:
transmit, to second UE, an indicator indicating one or more transmission starting points; and
receive, from the second UE during a shared channel occupancy time (COT), a sidelink communication at a first transmission starting point of the one or more transmission starting points, wherein the first transmission starting point is based on a priority associated with the sidelink communication.

25. The UE of claim 24, wherein:
the priority associated with the sidelink communication comprises a channel access priority class (CAPC) associated with the sidelink communication.

26. The UE of claim 24, wherein the indicator indicating the one or more transmission starting points comprises a lookup table mapping the one or more transmission starting points to a channel access priority class (CAPC),
wherein the lookup table maps multiple starting points of the one or more transmission starting points to a same CAPC, and
wherein the first transmission starting point is based on a hashing function of the multiple starting points.

27. The UE of claim 24, wherein the receiving the sidelink communication comprises receiving the sidelink communication in a time division multiplex (TDM) with one or more sidelink communications associated with one or more other UEs,
wherein the TDM is based on the priority associated with the sidelink communication.

28. The UE of claim 24, wherein the receiving the sidelink communication comprises receiving the sidelink communication in a frequency division multiplex (FDM) with one or more sidelink communications associated with one or more other UEs,
wherein the priority associated with the sidelink communication is a same priority associated with the one or more sidelink communications associated with the one or more other UEs.

29. The UE of claim 24, wherein the indicator indicating the one or more transmission starting points comprises:
a first codepoint field indicating a number of transmission starting points;
a second codepoint field indicating a location of the transmission starting points; and
a third codepoint field mapping the transmission starting points to the priority associated with the sidelink communication,
wherein the first codepoint field is based on a subcarrier spacing (SCS) associated with the sidelink communication,
wherein the second codepoint field is based on the number of transmission starting points in the first codepoint field, and
wherein the third codepoint field is based on the number of transmission starting points and a channel access priority class (CAPC) associated with the UE.

30. The UE of claim 24, wherein the transmitting the indicator indicating the one or more transmission starting points comprises transmitting, to the second UE, the indicator in sidelink control information (SCI),
wherein the transmitting the indicator indicating the one or more transmission starting points comprises transmitting the indicator in codepoints in the SCI, and
wherein a number of the codepoints in the SCI is based on a subchannel carrier spacing (SCS) associated with the sidelink communication.
